(19) United States
(12) Patent Application Publication
(10) Pub. No.: US 2025/0328027 A1
(43) Pub. Date: Oct. 23, 2025

(54) SYSTEM AND METHOD FOR THREE-DIMENSIONAL FLOATING IMAGE CONVERSION

(71) Applicant: Lixel Inc., Hsinchu City (TW)

(72) Inventors: CHUN-HSIANG YANG, Hsinchu City (TW); CHUN-LIN LIN, Hsinchu City (TW); YU-HSIEN LI, Hsinchu County (TW)

(21) Appl. No.: 18/906,426

(22) Filed: Oct. 4, 2024

(30) Foreign Application Priority Data
Apr. 19, 2024 (TW) 113114605

(51) Int. Cl. G02B 30/56; G06T 7/11; G06T 7/13; G06T 15/00; G06V 10/46; G06V 20/70

(52) U.S. Cl. CPC G02B 30/56; G06T 7/11; G06T 7/13; G06T 15/00; G06V 10/46; G06V 20/70; G06T 2207/10088; G06T 2207/10116; G06V 2201/07

(57) ABSTRACT

A system and a method for three-dimensional floating image conversion are provided. The system includes an image conversion system and an image display system. In the method, after an image is received, the image is segmented into multiple segmented images. An object in the multiple segmented images is recognized, and a 3D image modeling process is performed on the object from the multiple segmented images so as to establish a 3D model. A 3D image is then rendered. Next, a reference image that is used to reflect 3D coordinate values and color information of a 3D floating image being displayed by a floating-image display is generated based on the 3D image. The reference image is referred to for rendering multiple unit images and forming an integral image. The integral image can be used to project a 3D floating image through multiple optical elements of the floating-image display.

### CROSS-REFERENCE TO RELATED PATENT APPLICATION

This application claims the benefit of priority to Taiwan Patent Application No. 113114605, filed on Apr. 19, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for image conversion, and more particularly to a system and a method for three-dimensional floating image conversion through modeling by an artificial intelligent method.

### BACKGROUND OF THE DISCLOSURE

In general, one of the methods for reviewing a three-dimensional (3D) object from multiple directions using digital images is to capture images of the object from multiple viewing angles in a space. A 3D image processing technology is used to process the images so as to render a 3D image that can be displayed by a specific displaying technology. For example, a holography can be used to record information of light reflected by the object and light transmitted through the object. The information is such as amplitudes and phases of the reflected light and the transmitted light. The holography then reproduces a hologram of the object according to the information of the lights.

In the field of medicine, a computed tomography (CT) uses an X-ray to scan human body organs and a detector to read signals when the X-ray passes the human body. The signals are such as attenuations that are generated when the X-ray passes the human body organs. Therefore, the computed tomography relies on the attenuations to reproduce cross-sectional images of the scanned organ by a 3D computing technology. A 3D image of the organ can be rendered by stacking the cross-sectional images.

A magnetic resonance imaging (MRI) technology can further be used to change arrangement directions of hydrogen atoms in the human body after irradiating the human body placed in a magnetic field with electromagnetic waves and making hydrogen atoms resonate. A 3D image of the organs of the human body can be drawn through computer calculation based on the electromagnetic signals with respect to various tissues.

Many conventional 3D imaging methods have been developed, in which most of the 3D images are provided to be viewed through a flat display, or other images such as those of a hologram is required to be displayed by a holographic display.

### SUMMARY OF THE DISCLOSURE

In response to the above-referenced technical inadequacy, the present disclosure provides a system and a method for three-dimensional floating image conversion. The system converts an image into a 3D floating image to be displayed on a specific stereoscopic display. The system essentially includes an image conversion system and an image display system.

The image display system includes a floating-image display that has a display panel and a multi-optical element module consisting of multiple optical elements arranged in an array.

In the method for three-dimensional floating image conversion performed in the image conversion system, a received image is segmented into multiple segmented images, and one or more objects can be recognized in the multiple segmented images. The one or more objects in the multiple segmented images are labeled. A 3D image modeling process is then performed on the one or more objects recognized in the multiple segmented images, and a 3D model with respect to one of the objects is established. A 3D image is rendered from the 3D model. The 3D image and physical information of the multiple optical elements of the floating-image display are referred to for forming a reference image that is used to represent a spatial relative relationship. The reference image is formed from the 3D image through coordinate transformation, and is used to represent 3D coordinate values describing a 3D floating image displayed on the floating-image display.

In the image display system, the reference image is converted to the 3D floating image projected by the floating-image display.

Further, the image received by the image conversion system can be a medical image obtained by scanning an organism by a medical imaging system. The image is such as an X-ray image captured by an X-ray equipment, an ultrasound image obtained by scanning the organism with ultrasound equipment, sliced images of the organism obtained by scanning the organism with computed tomography equipment, or the images generated by scanning the organism with magnetic resonance imaging system. The image includes at least one tissue of interest.

Still further, in the step for image segmentation, the image is firstly binarized, and then an edge-detection algorithm and an edge-localization algorithm are performed on the binarized image so as to obtain direction and position of a contour of each of one or more objects in the image; afterwards, the image can be segmented by referring to the direction and position of the contour of each of the one or more objects in the image.

Further, in the method, an intelligence model is performed for recognizing one or more objects in the image or identifying the same one or more objects in the multiple segmented images, so that the segmented images having the specific one or more objects can be labeled.

The 3D image can be rendered based further on the 3D model and/or color information. The corresponding reference image is created for reflecting the 3D coordinate values of the 3D floating image or including the color information.

In one aspect, the optical elements of the floating-image display can form lens sets. The physical information for each of the optical elements indicates spatial relative relationship between a spatial position of the 3D floating image and each of among the lens sets. A unit image corresponding to each of the optical elements is created through calculation based on the reference image and the physical information of the optical elements of the floating-image display. Multiple unit images are provided to render an integral image to be displayed on the display panel.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a software process performed in an image conversion system according to one embodiment of the present disclosure;

FIG. 2 is a flowchart illustrating the method for three-dimensional floating image conversion according to one embodiment of the present disclosure;

FIG. 3 is a schematic diagram depicting a system that performs the method for three-dimensional floating image conversion according to one embodiment of the present disclosure;

FIG. 4 is a schematic diagram illustrating an operating framework of the system that performs the method for three-dimensional floating image conversion according to one embodiment of the present disclosure;

FIG. 5 is a schematic diagram depicting a floating-image display of the system according to one embodiment of the present disclosure;

FIG. 6 is a flowchart illustrating a process of generating an integral image according to one embodiment of the present disclosure; and

FIG. 7 is a schematic diagram that illustrates an image display system with interactive simulation function implemented through collaboration of hardware and software according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure relates to a method for three-dimensional floating image conversion and a system performing the method for three-dimensional floating image conversion. The system is consisting of a computer system that is used to perform image processing and a display system that is used to display a 3D floating image. One of the objectives is to convert a 2D image into the 3D floating image to be displayed on a floating-image display by an image-conversion technology.

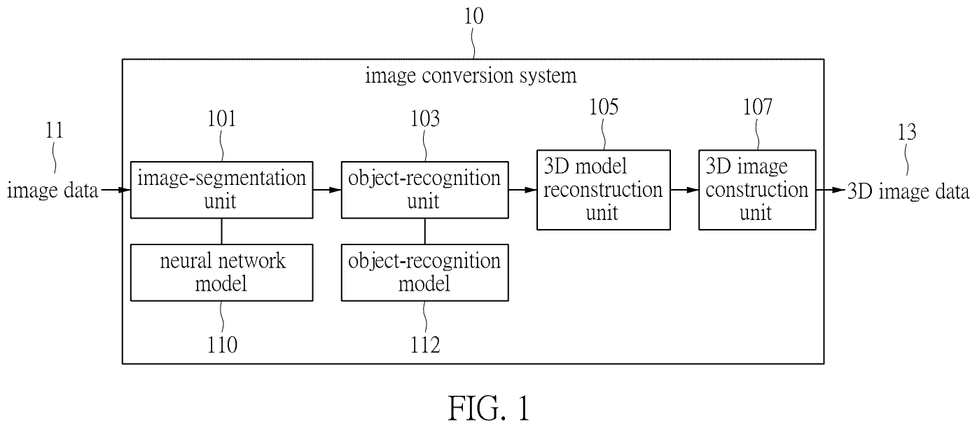

FIG. 1 is a schematic diagram illustrating an image conversion system according to one embodiment of the present disclosure. The image conversion system 10 that performs the method for three-dimensional floating image conversion is shown. The image conversion system 10 is implemented through collaboration of circuits of a processor and a memory of a computer system and software. The image conversion system 10 functionally includes an image-segmentation unit 101, an object-recognition unit 103, a 3D model reconstruction unit 105 and a 3D image construction unit 107.

According to one embodiment of the present disclosure, when the image conversion system 10 receives an image data 11, each of the images of the image data 11 is processed by the image-segmentation unit 101 of the image conversion system 10 for segmenting the image into multiple segmented images. It should be noted that the image is firstly analyzed for obtaining image features. The image is then segmented based on the image features. In one embodiment of the present disclosure, the image-segmentation unit 101 utilizes an intelligence model that is trained by a machine-learning algorithm to initially classify the image based on the image features (e.g., colors, brightness, edges and lines) and accordingly segment the image into multiple sub-image zones. The multiple sub-image zones allow the image conversion system 10 to easily process and recognize the images in subsequent processes, and the image conversion system 10 can label and tag the pixels with the similar image features. That means the pixels having the same tag(s) have the same or similar features. For example, the image includes one or more objects, and the image-segmentation unit 101 can classify the image according to the image features and distinguish the image into multiple sub-image zones if the image features such as colors and brightness of one of the objects are different from those of the other objects or a background image. The image can then be segmented by a neutral network model 110 that is trained with the segmented images.

Next, the object-recognition unit 103 is used to recognize the one or more objects in the image. The object-recognition unit 103 can adopt an intelligence model that is obtained by learning the image features with a machine-learning algorithm. The intelligence model is such as an object-recognition model 112 that is shown in the diagram and can be used to recognize the one or more objects in the image. If one or more objects are recognized from the image, the same objects can be distributed into the multiple sub-image zones. The object-recognition unit 103 labels the sub-image zones according to an object-recognition result. Afterwards, the same object can be determined from the multiple sub-image zones in the subsequent steps.

The object-recognition unit 103 recognizes the object(s) in the image and then identifies the edges of the object. In an exemplary example, the positions of the edges of the object can be detected by comparing ranges of grayscale changes in the image with a threshold predetermined by the system, so that the one or more objects can be determined from the image. Afterwards, the 3D model reconstruction unit 105 is able to perform 3D modeling on the images based on multiple images correlated with the object(s) and the sub-image zones that are obtained through image segmentation according to the image features.

Afterwards, for providing the data used to project the 3D floating image, the 3D image construction unit 107 of the image conversion system 10 obtains the multiple segmented images by the image-segmentation unit 101 and the objects to be recognized from the segmented images by the object-recognition unit 103 and reconstructs the 3D model of each of the one or more objects in the image. Further, the 3D model can be reconstructed with color information of the objects in the image, such that a 3D image can be rendered based on the 3D model and the color information.

Further, in the process of the 3D image construction unit 107 constructing a 3D image of the object, a 3D image data 13 that can reflect a 3D floating image can be generated based on design of the floating-image display. The 3D image data 13 can be used to reproduce the 3D floating image through the floating-image display or uploaded to a database (not shown in the diagram) of the server for providing imaging service. Details of relevant embodiments can be further referred to in the following description.

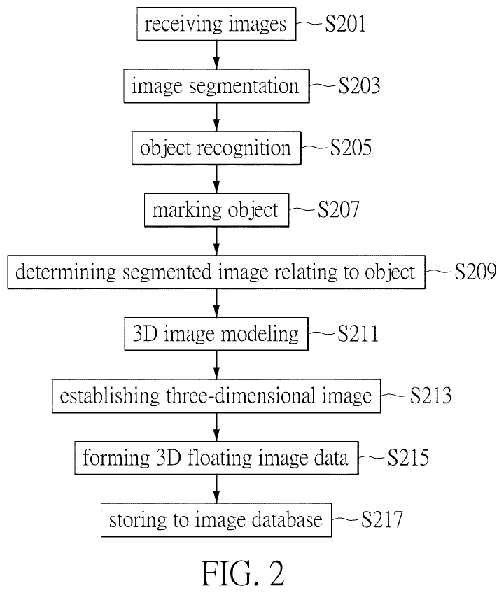

FIG. 2 is a flowchart illustrating the method for three-dimensional floating image conversion operated in the image conversion system illustrated in the above embodiment.

At the start of the method, the image conversion system receives an image, which can be a medical image obtained by scanning a biological body (e.g., a human body or a specific part of body) with a medical imaging system. The one or more objects in the medical image can be at least one tissue of interest of the biological body. The medical image covers one or more organs or tissues. For example, the medical image obtained by the medical imaging system can be an X-ray image that is captured by X-ray equipment, an ultrasound image obtained by scanning the biological body with ultrasound equipment, a sliced image obtained by scanning the biological body with computed tomography (CT) equipment, or a magnetic resonance imaging (MRI) image obtained by scanning the biological body with a magnetic resonance imaging system (step S201).

Next, each of the images is segmented so as to obtain the multiple segmented images (step S203). According to one embodiment of the present disclosure, the image is firstly binarized before the image is segmented. In the binarization process, the image is converted into black and white parts. An edge detection algorithm and an edge localization algorithm are performed on the binarized image for tracking a contour of each of the objects in the image. The edge-detection algorithm is to identify the edges of the object by checking changes of colors in pixels of the image by an image-processing process. That means, in the edge-detection algorithm, the position having a greater change of color has a high possibility to be determined as an edge. The edge-localization algorithm is then performed to confirm the position and direction of every edge so as to determine the contour of the object based on information of the edges. The above algorithms are used to obtain the direction and position of the contour of the one or more objects in the image. The information of the contour of the object acts as a reference for image segmentation. The algorithms are such as, but not limited to, Sobel, Canny and AdaBoost.

Afterwards, the one or more objects can be recognized from the segmented images (step S205). One of the schemes is, for example, an image-recognition technology that is performed on the image for retrieving the image features, or an intelligence model that is trained by a machine-learning algorithm is used to recognize the one or more objects in the image or parts of the multiple segmented images belonging to a same one of the one or more objects. The multiple segmented images having parts of the same object can be recognized and labeled.

According to one embodiment of the present disclosure, in the above steps S203 and S205, the medical image obtained by the computed tomography or the magnetic resonance imaging technology can be used to render a 3D anatomical image. Then, a computing circuit of the image conversion system performs a neural network (e.g., a convolutional neural network (CNN)) for training a model used to recognize a specific target object. For example, the above-mentioned object-recognition model 112 of the image conversion system 10 can be used to recognize the target object and then the image is segmented into multiple segmented images based on the determination of the contour of the object. Alternatively, the image can also be segmented into the multiple segmented images by the neural network model 110. Furthermore, the image conversion system 10 can also recognize the specific part of the object in each of the multiple segmented images.

For example, after the medical image is recognized as a whole human body or a specific organ, the neural network model is used to identify the object of interest (e.g., a specific human body organ) by positioning and labeling parts of the object of interest. The medical image is then segmented into multiple segmented images according to the image features or based on the labels in the medical image so as to form multiple segmented 3D images with respect to the human body organs.

According to one of the embodiments of the present disclosure, when the neural network model is trained, the different parts of the object of interest are positioned and can be coarsely segmented. Next, the object is distinguished into multiple segmented zones for acquiring training datasets with respect to the multiple parts by precisely segmenting the object. A machine-learning algorithm is used to learn the features of the various objects so as to establish the neural network models for the various objects. For example, the neural network models corresponding to the different human body organs are trained for recognizing the various parts of a specific organ.

Thus, one or more objects can be recognized one-by-one from the segmented images, and the images having the recognized one or more objects can be labeled from the multiple segmented images by means of software (step S207). Therefore, the image conversion system can rely on the labels to determine the multiple segmented images correlated with each of the objects, and then the segmented images having the object can be positioned (step S209). After that, from a large number of sliced images, a 3D image modeling process is performed on one or more objects recognized from the multiple segmented images, and especially performed one-by-one on the one or more objects according to the labels and positioning information of the recognized objects (step S211).

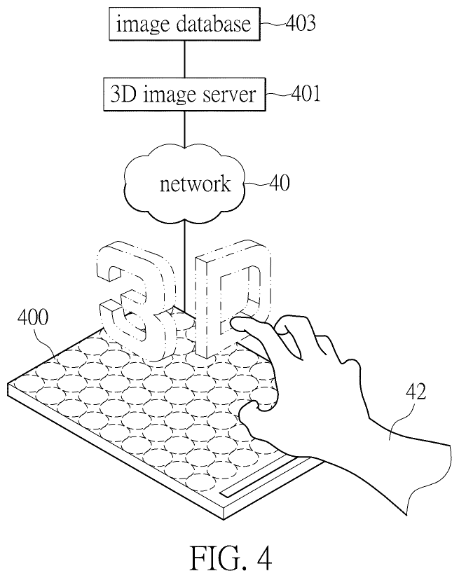

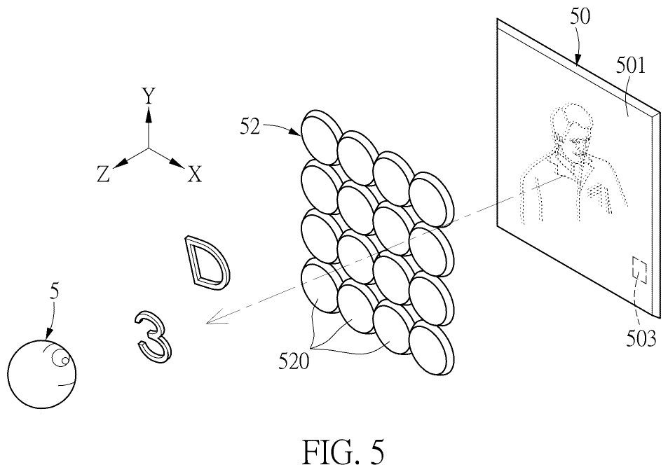

Next, a 3D image is rendered based on the 3D model (step S213). Specifically, the 3D image can also be rendered with the color information of the object. In particular, one of the objectives of the method for three-dimensional floating image conversion is to generate a 3D floating image, and a floating-image display is provided. Reference is made to an image display system shown in FIG. 4 or FIG. 5, the floating-image display includes a display panel and optical elements that are arranged in an array. Before using the floating-image display to project the 3D floating image, a reference image that reflects a spatial relative relationship is generated according to the 3D image and physical information of the optical elements of the floating-image display. The reference image is formed from the 3D image through coordinate transformation. The reference image is used to reflect the 3D coordinate values of the 3D floating image displayed by the floating-image display and can also be used to reflect both the 3D coordinate values and the color information of the 3D floating image.

After that, in an image display system, the reference image can be used to calculate a unit image corresponding to each of the optical elements that are arranged in an array in the floating-image display. Accordingly, multiple unit images corresponding to multiple optical elements are generated. These unit images are used to form an integral image for forming 3D floating image data (step S215) that can be stored into an image database (step S217). In the image display system, the multiple unit images are used to display the integral image on a display panel of the floating-image display by integrating the multiple unit images. The integral image can therefore be projected as a 3D floating image at a distance from the display panel through the multiple optical elements that are arranged in an array.

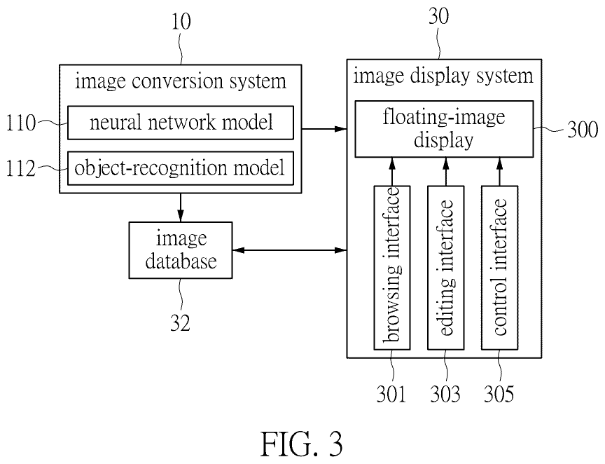

Reference is made to FIG. 3, which shows the system, which essentially includes an image conversion system 10 and an image display system 30. The image conversion system 10 implements image conversion by an artificial intelligence technology. According to one embodiment of the present disclosure, the image conversion system 10 uses the neural network model 110 to perform the step S203 for image segmentation illustrated in FIG. 2. The image conversion system 10 also uses the object-recognition model 112 to perform the step S205 for object recognition illustrated in FIG. 2 and the step S207 for labeling the object of FIG. 2.

After that, the segmented images with the recognized information of the object are referred to for performing 3D modeling. A 3D model with respect to each of the objects in the image is established. As shown in step S213 of FIG. 2, a corresponding 3D image is rendered, and in step 215 of FIG. 2, a corresponding 3D floating image data with respect to a floating-image display 300 of the image display system 30 shown in FIG. 3 is generated. The 3D floating image data can be stored to an image database 32. The image database 32 can be disposed in a cloud system and provided for the terminals connected with the cloud system to access the 3D floating image data. The 3D floating image data is used for each of the terminals to display a 3D floating image by the floating-image display 300.

According to one embodiment of the present disclosure, the image display system 30 retrieves the 3D floating image data from the image database 32, and uses the floating-image display 300 to display the 3D floating image. The image display system 30 also provides various manipulating tools such as a browsing interface 301 being provided for a user to perform gestures or various haptic devices for browsing and manipulating the 3D floating image. Further, one of the manipulating tools is an editing interface 303 that is provided for the user to perform gestures or the various haptic devices to directly edit the 3D floating image. Still further, another manipulating tool is such as a control interface 305 that acts as a user interface provided for the user to control the floating-image display 300.

FIG. 4 is another schematic diagram illustrating the image display system according to another embodiment of the present disclosure.

In addition to the floating-image display 400, the image display system also includes a 3D image server 401 that connects with the floating-image display 400 via a network 40. An image database 403 can be disposed in the 3D image server 401. The 3D image server 401 can provide the 3D floating image data according to an inquiry or a request made by a user via the network 40. The 3D floating image data can then be loaded into the image display system 30 and a corresponding 3D floating image is projected on a space at a distance above the display panel of the floating-image display 400 after a calculation performed by the floating-image display 400. The user can directly manipulate the 3D floating image with his hand 42 or other haptic tools.

According to an actual operation, when the user directly manipulates on the 3D floating image for interacting with the image, an interaction instruction is generated according to the changes of 3D coordinates formed by the gestures performed by the user. The image display system can query whether or not the data stored in the floating-image display 400 includes a next display mode corresponding to the interaction instruction. If the data stored in the floating-image display 400 already includes the next display mode, the floating-image display 400 can itself calculate a next 3D floating image to be displayed. Otherwise, if the data stored in the floating-image display 400 does not include the next display mode, the floating-image display 400 issues a request to the 3D image server 401 via the network 40 for requesting a new 3D floating image data. Therefore, the new 3D floating image data can be downloaded to the floating-image display 400 for displaying a new 3D floating image in response to the interaction.

Reference is made to FIG. 5, which is a schematic diagram illustrating the display technology of the floating-image display according to one embodiment of the present disclosure.

The main components of the floating-image display include a display panel 50 that can be, but not limited to, a flat liquid crystal display, and an image-processor unit 503 that is used to process image data for forming a display image 501. The display image 501 shows an integral image that is not yet reconstructed. This integral image does not appear to be any specific object in particular. The display panel 50 includes a multi-optical element module 52 having multiple optical elements 520 that are arranged in an array and some requisite circuits. Each of the optical elements 520 is such as a lens. The display image 501 displayed on the display panel 50 can be projected onto a space above the display panel through the multiple optical elements 520. Therefore, the user can see a 3D floating image that is formed by a real image from a viewing position 5.

As an exemplary example shown in the diagram, the user can see a 3D floating image “3D” from the viewing position 5. The display image 501 displayed on the display panel 50 is projected as the 3D floating image. The display image 501 can be an integral image composed of multiple unit images. Each of the unit images corresponds to a single optical element of the multi-optical element module 52. The optical element is such as a lens set that can be composed of one or more convex and concave lenses. The multiple optical elements form a lens array.

The optical elements (e.g., the lens sets) of the multi-optical element module 52 are disposed at different positions. When the multi-optical element module 52 is used to project a floating 3D image, the floating 3D image can be seen at a specific viewing position 5. It should be noted that the image projected through a corresponding optical element 520 at a specific position is configured to be projected onto a predetermined spatial position, and therefore the images to be projected through the optical elements 520 at different positions are different. This means that the unit images corresponding to different optical elements are different from each other.

For example, while projecting a 3D floating image, the optical element on the left side of projected 3D image should project a unit image with a projection angle to the left of the 3D image. Similarly, the optical element on the right side of the projected 3D image should project the unit image with a projection angle to the right of the 3D image. Further, the optical elements below the 3D image should project an upward image through the unit images that are just below the 3D image. Moreover, the 3D floating image is displayed as floating in the air at a distance from a display plane. The floating image can be sunken down in the display plane in other embodiments.

Further, the 3D floating image data stored in the image database records the 3D coordinates and chromatic information of the 3D image, for example, the color information or 3D spatial information of the 3D image. In one further embodiment of the present disclosure, the 3D coordinates and chromatic information of the 3D image may contain a 2D image and a depth map. The floating-image display essentially consists of a display panel 50 and a multi-optical element module 52. The multi-optical element module 52 has a spatial relative relationship with the 3D floating image to be displayed in a space. The reference image is rendered for the purpose of reflecting the spatial relative relationship. The reference image can be used to reflect a final 3D floating image. According to one of the embodiments of the present disclosure, the reference image is rendered by calculating an image inputted to the image conversion system and processed through coordinate transformation. Therefore, the reference image can be used to represent the 3D coordinate values and color information of the 3D floating image. Next, the image conversion system can rely on the physical information relating to the multi-optical element module 52 to calculate the unit image corresponding to each of the optical elements 520. The multiple unit images corresponding to the multiple optical elements 520 form an integral image provided to the display panel 50. The integral image is displayed on the display panel 50 and then appears as a 3D image through the multi-optical element module 52.

It is worth noting that the above-mentioned physical information of the multi-optical element module 52 is mainly directed to the physical characteristics of the optical elements 520, and at least the spatial relative relationship between the spatial position of the displayed 3D floating image and each of the optical elements 520. For example, the spatial relative relationship includes a distance and a relative angle between the 3D floating image and each of the optical elements (e.g., the lens sets) 520, and the spatial relation (e.g., a spacing) between each of the optical elements 520 and the display panel 50.

The spatial relation can be understood by placing the system in identical spatial coordinates. Through this, the distance and the relative angle between the 3D floating image and each of the optical elements 520 can be calculated according to the spatial coordinates of the 3D floating image and the coordinates of each of the optical elements 520, and the relative positions among the optical elements 520 of the system can also be obtained. A distance between every optical element and the display panel can be obtained. The spatial relation may also include the relative position of each optical element of the multi-optical element module 52. The spatial relation also includes a relative distance between every optical element, and relative distance between every optical element and the display panel 50. The spatial relation is introduced to the calculation with the sizes of image pixels. The various spatial relations become the inputs for the method for rendering the 3D image. The inputs of the method further include a viewing position 5 of the user so as to set up an oblique angle for displaying the 3D floating image. A ray tracing aspect is then introduced to the method in order to create the plurality of unit images, and the display panel displays the integral image that is not yet reproduced.

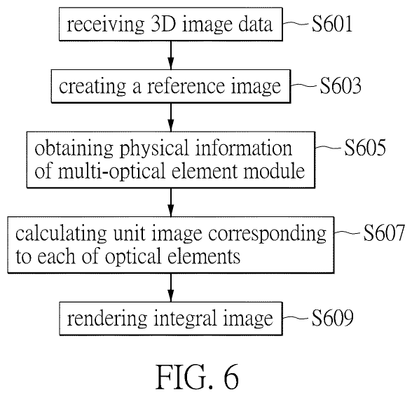

FIG. 6 is a flowchart illustrating a process of rendering the integral image to be displayed on the display panel 50 according to one embodiment of the present disclosure.

In the process starting with step S601, the system retrieves 3D image data from an image database. The 3D image data is such as the 3D floating image data obtained through image conversion in the above embodiment. The image database records the color information and the 3D spatial information of the 3D floating image. The 3D spatial information is exemplified as the information of a plane image and a depth map, or a set of coordinate values and chromaticity value. The information of the plane image includes pixel coordinates (x, y) and chromatic value. The depth map records a depth value (z value) of every pixel of the plane image. The depth map allows the system to reproduce the 3D floating image by describing the spatial positions through the 3D coordinate values (x, y, z). The chromatic value is then added for accurately showing the colors of the 3D image.

After that, in step S603, the system creates a reference image according to the received 3D floating image information and user requirements. The user requirements are, for example, the user's viewing position, or a projection position of the 3D image. The system can automatically detect the user's viewing position according to the position of the user's eyeball and accordingly create the reference image. The reference image is used to represent the 3D coordinate values and chromaticity of the 3D floating image. In one embodiment, the original 3D floating image inputted to the system is converted to the reference image through a coordinate transformation. A coordinate transformation algorithm is particularly utilized to compute a set of transformation parameters.

Next, in step S605, the system obtains the physical information of multiple optical elements. The physical information includes the size and properties of the optical element, coordinates, size and curvature of the single lens set and the lens array, and the spatial relations of the optical elements. The spatial relations of the optical elements include the spatial position related to the single optical element, the spatial relation between each optical element and the display unit or display panel, and the spatial relation between the projecting position and every optical element. In step S607, the system establishes a coordinate transformation function between the original information of the 3D floating image and the reference image. Through the coordinate transformation algorithm, the system uses the physical information of the optical elements and the coordinate transformation function to derive the unit images corresponding to the optical elements from the reference image.

In step S609, an integral image can be rendered from the unit images that are displayed on the display device. More specifically, the unit images are provided for the image display including the display panel and backlight module of display device to display the integral image. The integral image finally becomes the 3D image through the multi-optical elements. The 3D floating image is consistent with the reference image that can be set up by users or generated by the system.

It is noted that the reference image is rendered based on the positions of the optical elements of the display panel. The optical elements can be set up in the display panel in one-to-one, one-to-many or many-to-one manner. To render the reference image, the system does not have to refer to the user's viewing position. However, the system still allows the user to view the 3D floating image from an oblique viewing angle. Therefore, the unit images may be altered based on a specific circumstance. The 3D floating image can be reproduced in a floating manner above the display device, in a sinking manner below the display device, or in front of or at the rear of the display device when the lights are converged through the multi-optical elements. The algorithm acknowledges the diversities among the unit images and the integral image from the reference image based on the user requirements, including the user's viewing position.

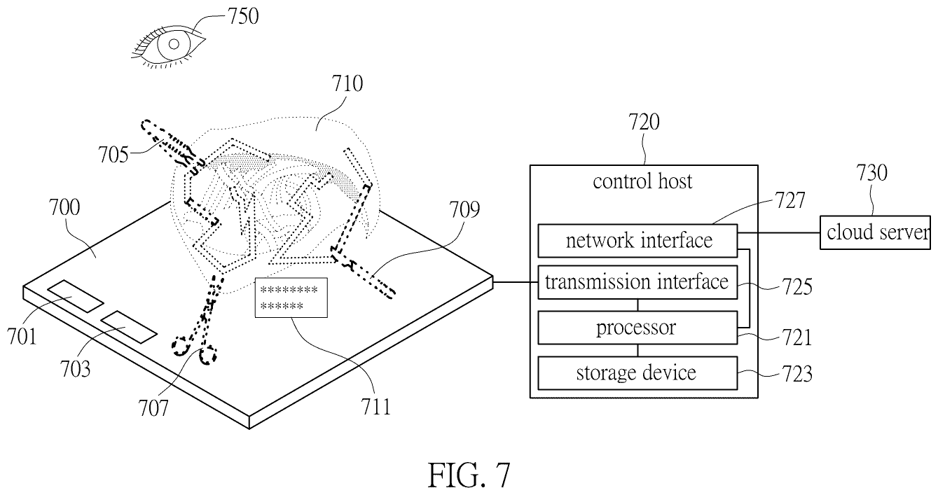

According to one embodiment of the present disclosure, the 3D floating image obtained by the method for three-dimensional floating image conversion can be a medical image that is rendered through a 3D modeling and generating process. The medical image can be a human body organ. The medical image can be provided for medical personnel to conduct a simulation course for surgery. FIG. 7 is a schematic diagram illustrating the image display system implementing interactive simulation functions through collaboration of hardware and software in the present embodiment.

Reference is made to FIG. 7, which is a schematic diagram illustrating the image display system with interactive simulation functions in one embodiment of the present disclosure. A floating-image display 700 is provided in the system. According to one of the embodiments of the present disclosure, the floating-image display 700 essentially consists of an optical element layer, a display panel and a backlight module. The optical element layer is formed of a lens array. The display panel can be a liquid crystal display panel that is disposed between the optical element layer and the backlight module. The display having the display panel can also be other types of displays having the backlight module, or an organic LED display with self-luminous properties. The floating-image display 700 includes an image processor that can be used to process the display content and a communication element that is capable of retrieving 3D image data from an external source. The 3D image data can be processed to render an initial image provided to the display panel. The initial image can be focused and projected onto the floating-image display 700 via the optical element layer. A 3D image 710, which can be such as a floating 3D image, is therefore formed.

According to one embodiment of the floating-image display 700, in addition to the above-mentioned components, for implementing a teaching simulation and allowing the user to perform interactive manipulation, the floating-image display 700 provides an interactive sensor such as a gesture sensor 701. The gesture sensor 701 uses an optical detection technology or an image processing method to detect the gesture that the user performs to manually manipulate the 3D image 710 or the gesture that is made by manipulating various haptic devices 705, 707 and 709. In a practical example, the quantity of the haptic devices 705, 707 and 709 is not limited to the example shown in the figures. The quantity of the haptic devices 705, 707 and 709 that can operate simultaneously is determined based on a capability of data processing of the interactive simulation system, so that the system can simultaneously process the sensing data generated by one or more haptic devices 705, 707 and 709. Further, the gesture sensor 701 can be used to sense the gesture of the user or the action performed through the one or more haptic devices 705, 707 and 709. The sensing data generated by the gesture sensor 701 refers to 3D coordinate variations so as to generate an interactive instruction by a control host 720. According to one embodiment of the present disclosure, when the user manipulates the haptic devices 705, 707 and 709 to act on the 3D image 710, an action sensor in each of the haptic devices 705, 707 and 709 is used to generate sensing data that refers to 3D coordinate variations in a 3D space, and a receiver disposed in the floating-image display 700 receives signals of the actions performed by the haptic devices 705, 707 and 709. It should be noted that the action sensor can be an accelerometer or a gyroscope built in the haptic device. The control host 720 processes the sensing data that is formed into an interactive instruction.

Still further, the image display system includes an eye detector 703 that is implemented by collaboration of hardware and software. The eye detector 703 is disposed on the floating-image display 700. The eye detector 703 acquires an image of the user's face including an eye 750 by a sensor. The image is then processed by a software means so as to determine a position of the user's face according to the features of the image. The position of the eye 750 can be detected based on the features of the eyes. The position of the eye 750 may indicate the position of one or two eyes of the user. A set of coordinates can be used to describe the position of the eye 750, and the coordinates are transformed to the coordinates at the same coordinate system with the floating-image display 700.

According to the above description of the embodiment, the image display system can display the 3D image 710 via the floating-image display 700 according to the position of the eye 750 detected by the eye detector 703. The floating-image display 700 can use the gesture sensor 701 to determine the gesture performed by the user or the action generated by manipulating the haptic devices 705, 707 and 709 so as to display the 3D image 710 in response to the gesture or the action. The 3D image 710 that responds to the gesture or the action achieves a purpose of teaching simulation and virtual interaction.

For enhancing the effect of teaching simulation, not only is the position of the eye 750 referred to for updating the 3D image 710, but an annotation 711 can also be appended to the 3D image 710 for reference. The 3D image 710 can be updated instantly according to the position of the eye 750. One of the main technologies is to provide a control mechanism to control the circuits and software operated in the system so as to translate the gesture performed by the user or the action generated by manipulating the haptic devices 705, 707 and 709 into an interactive instruction applied to the 3D image 710.

According to one of the embodiments of the present disclosure, the control mechanism can be a computer-implemented control host 720 that includes a processor 721 and a storage device 723. The control host 720 can externally connect with the floating-image display 700 via a specific industrial standard connection, i.e., the transmission interface 125. In one of the embodiments of the present disclosure, the control host 720 can be a computer system that serves as a local site. The control host 720 can control the one or more floating-image displays 700 connect with the local sites and provides the corresponding 3D image data. On the other hand, the interactive simulation system provides a cloud server 730. The one or more control hosts 720 can connect with the cloud server 730 via a network interface 727. The cloud server 730 provides the computation and database services for one or more control hosts 720 at different locations.

In conclusion, according to the above embodiments of the system and the method for three-dimensional floating image conversion, in addition to the above-described example of medical teaching, the method and the system can also be applied to other fields, such as security inspection for a specific device, circuit checking, and reverse engineering. The medical images and the images generated by various devices can be segmented in advance, and then the corresponding 3D image can be generated through a 3D modeling method. The 3D image is then converted into a 3D floating image that can be displayed by a floating-image display. A user can manipulate the displayed 3D floating image by a tool or a gesture.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for three-dimensional floating image conversion, comprising:
receiving an image;
segmenting the image into multiple segmented images;
recognizing one or more objects in the multiple segmented images and labeling one or more segmented images having the one or more objects;
performing a 3D image modeling process on one of the one or more objects so as to establish a 3D model based on the one or more objects recognized from the multiple segmented images, and rendering a 3D image using the 3D model; and
rendering a reference image reflecting a spatial relative relationship based on physical information of the 3D image and optical elements of a floating-image display, wherein the reference image is formed from the 3D image after coordinate transformation and the reference image is used to reflect 3D coordinate values of a 3D floating image displayed by the floating-image display.

2. The method according to claim 1, wherein the image is obtained by scanning a human body through a medical imaging system, and the one or more objects in the image represents one or more organs or tissues of the human body.

3. The method according to claim 1, wherein the step of segmenting the image comprises:
binarizing the image;
performing an edge-detection algorithm and an edge-localization algorithm on the binarized image so as to obtain direction and position of a contour of each of one or more objects in the image; and
segmenting the image by referring to the direction and position of the contour of each of the one or more objects in the image.

4. The method according to claim 1, wherein the one or more objects are recognized from the image, or parts of the multiple segmented images belonging to a same one of the one or more objects are recognized through an intelligence model so as to label the images having the one or more objects from the multiple segmented images.

5. The method according to claim 1, wherein the 3D image is rendered based on at least one of the 3D model or color information and the reference image corresponding to the 3D image reflects at least one of 3D coordinate values of the 3D floating image or the color information.

6. The method according to any of claim 1 to claim 5, wherein the floating-image display includes a multi-optical element module and a display panel, the multi-optical element module having multiple optical elements that are arranged in an array, and the physical information of the optical elements of the floating-image display is a spatial relative relationship between spatial position of the 3D floating image and each of the optical elements.

7. The method according to claim 6, wherein a unit image corresponding to each of the optical elements is calculated according to the reference image and physical information of the optical elements of the floating-image display, and multiple ones of the unit image are used to render an integral image to be displayed on the display panel.

8. A system operating a method for three-dimensional floating image conversion, wherein the system comprises:
an image conversion system; and
an image display system having a floating-image display, wherein the floating-image display comprises a display panel and a multi-optical element module having multiple array-arranged optical elements;
wherein the steps performed in the image conversion system comprise of:
receiving an image;
segmenting the image into multiple segmented images;
recognizing one or more objects in the multiple segmented images and labeling one or more the segmented images having the one or more objects;
performing a 3D image modeling process on one of the one or more objects so as to establish a 3D model based on the one or more objects recognized from the multiple segmented images, and rendering a 3D image using the 3D model; and
rendering a reference image reflecting a spatial relative relationship based on physical information of the 3D image and the optical elements of the floating-image display, wherein the reference image is formed from the 3D image after coordinate transformation and the reference image is used to reflect 3D coordinate values of a 3D floating image displayed by the floating-image display;
wherein, in the image display system, the 3D floating image projected by the floating-image display is rendered by referring to the reference image.

9. The system according to claim 8, wherein the image received by the image conversion system is a medical image that is obtained by scanning a biological body through a medical imaging system, and the medical image comprises at least one tissue of interest.

10. The system according to claim 9, wherein the medical image generated by the medical imaging system is an X-ray image that is captured by X-ray equipment, a ultrasound image obtained by scanning the biological body with ultrasound equipment, a sliced image obtained by scanning the biological body with computed tomography equipment, or an MRI image obtained by scanning the biological body with a magnetic resonance imaging system.

11. The system according to claim 8, in the step of segmenting the image in the method for three-dimensional floating image conversion, comprising:
binarizing the image;
performing an edge-detection algorithm and an edge-localization algorithm on the binarized image so as to obtain direction and position of a contour of each of one or more objects in the image; and
segmenting the image by referring to the direction and position of the contour of each of the one or more objects in the image.

12. The system according to claim 8, wherein the one or more objects are recognized from the image, or parts of the multiple segmented images belonging to a same one of the one or more objects are recognized through an intelligence model so as to label the images having the one or more objects from the multiple segmented images.

13. The system according to claim 8, wherein the 3D image is rendered based on at least one of the 3D model or color information and the reference image corresponding to the 3D image reflects at least one of 3D coordinate values of the 3D floating image or the color information.

14. The system according to any of claim 8 to claim 13, wherein each of the optical elements of the floating-image display is a lens set, and the physical information of each of the optical elements is a spatial relative relationship between spatial position of the 3D floating image and every lens set.

15. The system according to claim 14, wherein a unit image corresponding to each of the optical elements is calculated according to the reference image and physical information of the optical elements of the floating-image display, and multiple ones of the unit image are used to render an integral image to be displayed on the display panel.
